(19) United States
(12) Patent Application Publication
(10) Pub. No.: US 2018/0213935 A1
(43) Pub. Date: Aug. 2, 2018

(54) IMPACT PROTECTION DEVICE CLIP

(71) Applicant: Innovation Central Pty Ltd, Payneham (AU)

(72) Inventors: Ian Howard PENDERGRAST, Woodcroft (AU); Paul HUXTABLE, Trinity Gardens (AU)

(21) Appl. No.: 15/745,096

(22) PCT Filed: Jul. 19, 2016
(86) PCT No.: PCT/AU2016/050640

§ 371 Date: Jan. 15, 2018

(30) Foreign Application Priority Data
Jul. 22, 2015 (AU) 2015902906

(51) Int. Cl. A47B 95/04; F16B 12/40; F16B 12/10; B65G 1/02

(52) U.S. Cl. CPC A47B 95/043; F16B 12/40; B65G 2207/40; B65G 1/02; A47B 2095/046; F16B 12/10

(57) ABSTRACT

The present invention relates to an impact protection device clip configured to locate an impact protection device about a post of a racking system. The post of such racking system includes a cross-sectional wall profile defining a chamber with an opening. The clip includes a body arranged in use to extend through said opening of the post. The body further includes first and second attachment devices for enabling attachment of the clip to the impact protection device, and at least one contact. The at least one contact is configured so that if the protection device is moved in a first direction causing a part of the protection device to be pulled generally away from the post, the contact engages against an inner face of the cross-sectional wall profile of the post so that the engagement between the contact of the clip and the post resists further movement of the protection device in the first direction.

The present invention also provides a method of preventing inadvertent removal of a clip from an impact protection device located about a pallet racking post. The post includes a cross-sectional wall profile defining a chamber with an opening, and the clip includes a body with at least one contact. The method includes the steps of: positioning the at least one contact of the clip so that the contact is received in the chamber of the post and the body extends through the opening of the post; and attaching the clip to the impact protection device so that the impact protection device is located about the post. In this way, when the impact protection device is subject to an impact or other contact that causes a part of the impact protection device to move generally away from the post, the clip is arranged to resist further movement of the impact protection device away from the post by establishing an engagement between the at least one contact of the clip and an inner face of the cross-sectional wall profile of the post.

The present invention further provides a kit including an impact protection device for a pallet racking post and at least one impact protection device clips.

### RELATED APPLICATION

This application claims convention priority from Australian provisional patent application 2015902906 filed on 22 Jul. 2015. The contents of that application are incorporated herein by reference.

### TECHNICAL FIELD

This invention relates to an impact protection device clip for locating an impact protection device about a post of a pallet racking system. Typically, such impact protection devices are used on the posts of warehouse racking systems to protect them from damage due to forklift impact.

### BACKGROUND OF INVENTION

Warehouses around the world store goods on steel frames typically referred to as “pallet racking”. The term “pallet” is adopted because the goods are normally loaded on pallets and the loaded pallets are stored on the steel frames. Storage on pallets is preferred because it enables the goods to be quickly lifted and transported to another location using a material handling vehicle such as a forklift.

Typically, pallet racking includes posts that are made from roll formed steel. The thickness of the steel used to form the posts may vary, for example from about 1.6 mm to about 2.5 mm. Further, the profile shape of the posts is quite variable. FIG. 1 illustrates the profile shape of a number of different posts used in pallet racking. Such posts are vulnerable to impact by material handling vehicles and if they are damaged, replacement is both expensive and time consuming.

A wide range of impact protection devices are available to protect the posts of pallet racking systems from inadvertent impact by material handling vehicles. Some such impact protection devices are bolted to the floor whilst others are attached to the actual pallet rack post. Typically, impact protection devices are “clipped” to the posts, but they may also be attached using fasteners, for example hook and loop type fastener systems (i.e. VELCRO®).

WO 2005/049453 describes and illustrates a number of different impact protection devices of the type used on pallet racking. As shown in FIG. 1 of WO 2005/049453, multiple protection devices can be located about a post and are typically “snapped” or “clipped” onto the post to locate them relative to the post. The protection devices are used singularly or stacked one on top of the other to provide protection for a substantial portion of the length of the post. The protection devices are arranged to flex when impacted and thereby absorb any impact force, preventing damage to the post. Under severe impact force, one or more of the protection devices may be damaged and in that event, they should be removed and replaced with a new protection device. It will thus be appreciated that although it is necessary for the impact protection devices to be secured to the posts so as to prevent inadvertent removal, they must also be relatively easily removable so that minimal effort is required to replace a damaged protection device. Further, it is normally a safety requirement to inspect the posts of pallet racking on a regular basis to ensure their integrity. This requires removal of all of the protection devices and thus ease of removal of the protection devices is an important factor when considering which protection device to make use of. Preferably, installation and removal of the protection devices should be achievable by hand, without the need for a special tool to manipulate the protection device on and/or off the post.

It should also be noted that it is desirable for impact protection devices to have the capability to be used in conjunction with posts of a number of different profiles. This enables a single form of impact protection device to be used in a warehouse that may be fitted with pallet racking of different post profiles.

Another difficulty with conventional protection devices is that their “snap”, “clip” or other form of connection to the pallet racking post means that they can be inadvertently dislodged from the post. For example, when a pallet of product is being removed off the pallet racking, the protection device may be struck or caught from behind by the pallet as it is being moved off the racking, causing the protection device to be dragged away and off the post. Accordingly, there is design tension between securing the protection device in a manner to ensure that it is not inadvertently dislodged from about the post and being able to readily remove the protection device to enable post inspection or replacement of a damaged protection device.

The present invention provides an impact protection device clip that can be used to securely locate an impact protection device about a pallet racking post.

The discussion of the background to the invention herein is included to explain the context of the invention. This is not to be taken as an admission that any of the material referred to was published, known or part of the common general knowledge as at the priority date of this application.

### SUMMARY OF INVENTION

According to the present invention there is provided an impact protection device clip, said clip configured to locate an impact protection device about a post of a racking system, said post including a cross-sectional wall profile defining a chamber with an opening, said clip including a body arranged in use to extend through said opening, said body further including first and second attachment devices for enabling attachment of the clip to said impact protection device, and said body including at least one contact, and wherein the at least one contact is configured so that if the protection device is moved in a first direction causing a part of the protection device to be pulled generally away from the post, the contact engages against an inner face of the cross-sectional wall profile of the post so that the engagement between the contact of the clip and the post resists further movement of the protection device in the first direction.

In accordance with one embodiment of the invention, the clip is arranged for use with a post having a chamber with a width dimension greater than a width dimension of the opening. The clip preferably includes first and second contacts that have a maximum width dimension (i.e. outer side to outer side) greater than the width dimension of the opening of the chamber but less than or substantially equal to the width dimension of the chamber. If the protection device is moved in a first direction causing a part of the protection device to be pulled generally away from the post, at least one of the first and second contacts engage against the inner face of the cross-sectional wall profile so that the engagement between the at least one of the first and second contacts and the post resists further movement of the protection device in the first direction. Further, removal of the clip from the chamber requires the clip to be orientated so that the first and second contacts can pass through the opening.

Preferably, when the part of the protection device is moved in the first direction both the first and second contacts each engage against respective parts of an inner face of the cross-sectional wall profile of the post so as to prevent a twisting movement of the clip.

In use, the width dimensions as measured of the chamber, the opening, and between the first and second contacts, preferably extend substantially parallel to one another.

In use, the width dimensions as measured of the chamber, opening, and between the first and second contacts, preferably extend in a plane substantially perpendicular to a length direction of the post of the pallet racking system.

The first and second contacts are preferably located on what hereafter will be referred to as an inner end of the body. The reference to “inner” refers to a part of the body intended to be located within the chamber of the post during use of the clip.

The first and second contacts are preferably located on respective first and second fingers of the clip. Multiple first and second contacts may be located on the respective first and second fingers so that first and second contact zones may be established.

The width dimension of the first and second contacts is preferably measured from an outer most edge of the first finger to an outer most edge of the second finger.

The first and second fingers preferably extend outwardly from a first end of the body and at an angle to one another. The first and second attachment devices are preferably located on the body distal to the first and second fingers.

The body is preferably elongated so that in use of the clip, the first and second attachment devices are located outside of the chamber. The body has a body width dimension less than the width dimension of the opening of the chamber so that the body may extend through said opening during use of the clip.

In accordance with an embodiment of the invention, the body includes a pair of arms that each includes a first portion that extends in use of the clip generally perpendicular to the width dimension of the chamber. Each arm preferably further includes a second portion that extends generally parallel to the width dimension of the chamber. The first attachment device is preferably located on a distal end part of the second portion of the first arm. The second attachment device is preferably located on a distal end part of the second portion of the second arm.

In use of a preferred embodiment of the invention, the contact or contacts are arranged to be received in the chamber, and the first and second attachment devices are arranged to be located externally of the chamber. The first and second attachment devices are attached to the impact protection device thereby retaining the contacts or contacts of the clip within the chamber of the post. If the impact protection device is subject to an impact, the clip is arranged to retain the impact protection device about the post, preventing inadvertent removal of the impact protection device therefrom.

Inadvertent removal of the impact protection device from about the post is prevented by at least some part of one contact, or both the first and second contacts, or all of the contacts, or the body of the clip engaging against one or more parts of an inner face of the cross-sectional wall profile of the post so as to prevent the contact(s) of the clip exiting the chamber. For example, one or both of the first and second contacts may engage against a respective part of the inner face of the cross-sectional wall profile of the chamber when a part of the impact protection device is moved in a first direction. This engagement resists further movement of the protection device in the first direction. Depending on the orientation of the first direction, the actual position of the engagement of the contacts with the inner face of the cross-sectional wall profile will vary. For example, the engagement may also prevent the first and second contacts, and thus the inner end of the clip, from inadvertently exiting the chamber. It will thus be appreciated that when the impact protection device is impacted or pulled resulting in movement of the protection device, a part of the clip, and more preferably one or more of the first and second contacts, engages against the inner face of the cross-sectional profile of the post preventing further movement of the impact protection device that may otherwise potentially dislodge the clip from engagement with the impact protection device. The engagement between the contacts and the post, together with the first and second attachment devices being attached to the protection device, prevents the inner end of the clip from being removed from the chamber.

Embodiments of the present invention are advantageous because they can be used with pallet racking posts with a wide range of profiles and size. Furthermore, the first and second attachment devices of the clip can be configured so that they can be secured to different impact protection devices. Further, either a single or multiple such clips can be used to locate an impact protection device about a post.

It will also be appreciated that embodiments of the clip are advantageous in use because they are configured to enable the impact protection device to be moved longitudinally along the length of the pallet racking posts (i.e. along the length of the opening) without removal of the clip. This is possible because the clip associated with each impact protection device is not connected using any sort of fixing (e.g. screw, magnet, tie) to the pallet racking post. As such, the impact protection device can be moved along the length of the post to enable visual examination of the post or attachment of a further impact protection device without need to remove the clip.

Attachment of the clip to the impact protection device can be done by hand, without need of any hand tool.

It is recognised that in accordance with preferred embodiments of the invention, no part of the clip will contact an outer face of the cross-sectional wall profile of the post of the pallet racking system when the clip is in normal use.

Preferably, the clip is configured or made of a material so as to be resiliently flexible to enable the clip some degree of flexure (e.g. expansion or contraction) to facilitate attachment of the clip to a range of different impact protection devices.

The invention also provides a method of preventing inadvertent removal of a clip from an impact protection device located about a pallet racking post, said post including a cross-sectional wall profile defining a chamber with an opening, said clip including a body with at least one contact, said method including the steps of:
positioning the at least one contact of the clip so that the contact is received in the chamber of the post and the body extends through the opening of the post; and
attaching the clip to the impact protection device so that the impact protection device is located about the post
   whereby when the impact protection device is subject to an impact or other contact that causes a part of the impact protection device to move generally away from the post, the clip is arranged to resist further movement of the impact protection device away from the post by establishing an engagement between the at least one contact of the clip and an inner face of the cross-sectional wall profile of the post.

### BRIEF DESCRIPTION OF DRAWINGS

Embodiments of the invention will now be described, by way of example only, with reference to the accompanying drawings in which:

FIG. 1 illustrates the cross-sectional wall profile of eight different pallet racking posts;

FIG. 2 illustrates an isometric view of an impact protection device clip according to an embodiment of the invention;

FIG. 3 is a top plan view of the impact protection device clip shown in FIG. 2;

FIG. 4 is a cross-sectional view of a pallet racking post fitted with a protection device which is secured in position about the post with the impact protection device clip as shown in FIGS. 2 and 3;

FIGS. 5A to 5D are respective cross-sectional, front, side and back views of a pallet racking post fitted with a protection device which is secured in position about the post with the impact protection device clip as shown in FIGS. 2 and 3. The post has a different cross-sectional wall profile to the post shown in FIG. 4;

FIG. 6 is a cross-sectional view of another pallet racking post fitted with a protection device which is secured in position about the post with the impact protection device clip as shown in FIGS. 2 and 3; and

FIGS. 7A to 7D illustrate the steps involved in connecting an impact protection device clip to an impact protection device fitted about a pallet racking post.

### DETAILED DESCRIPTION

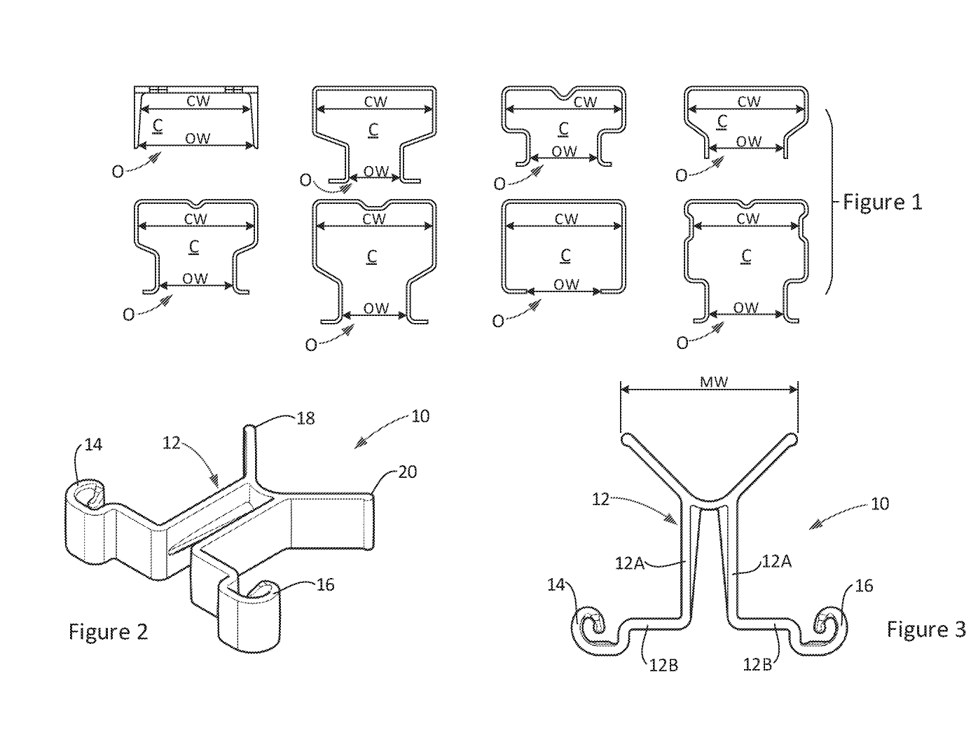

An impact protection device clip according to an embodiment of the invention may be used to locate a variety of different shaped impact protection devices about pallet racking posts of differing cross-sectional wall profile. However, the cross-sectional wall profile of the post must be discontinuous so as to include an opening through which the clip can be passed into a chamber defined by the cross-sectional profile. Indeed, FIG. 1 illustrates eight different post profiles about which an impact protection device could be located using a clip according to an embodiment of the invention. The illustration of such profiles is not intended to be limiting. It will be noted that each post cross-sectional wall profile defines a chamber C with an opening O. Each chamber C has a width dimension CW and an opening dimension OW. With the exception of the first illustrated profile, the maximum width dimension CW of the post profile is generally greater than the opening dimension OW. Each cross-sectional profile has an inner face extending from one side of the opening O, about the profile, to the other side of the opening O.

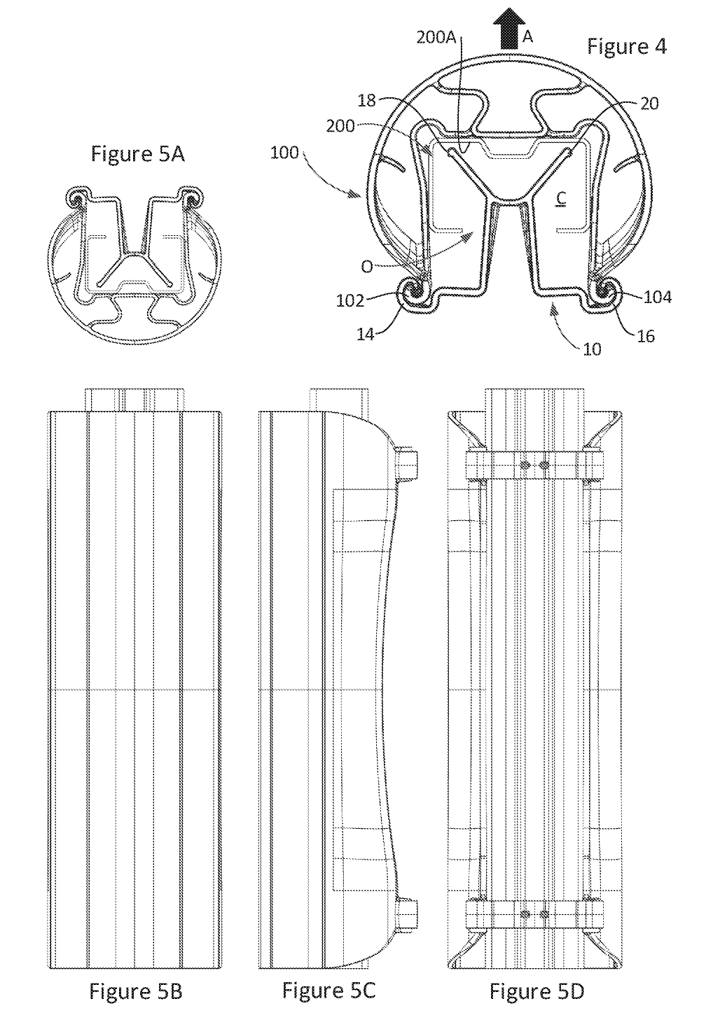

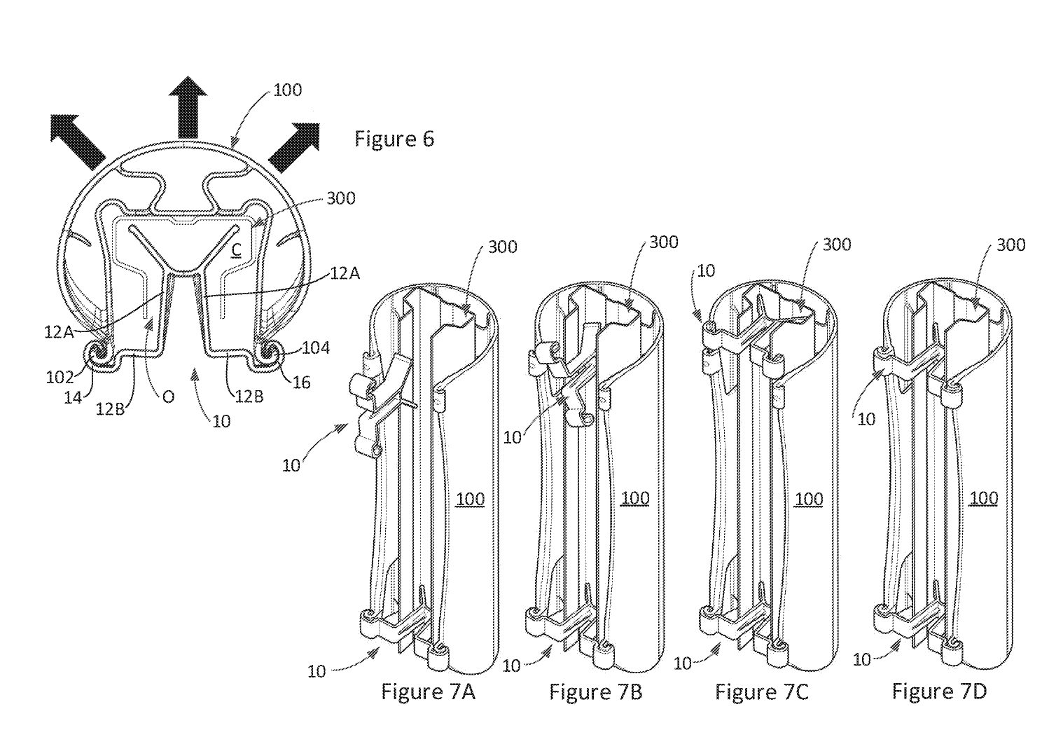

To simplify the following description, reference will be made to a protection device 100 as illustrated in FIGS. 4 to 7D. It will also be noted that FIGS. 4 to 5D depict a first post configuration 200, and FIGS. 6 to 7D depict a second post configuration 300. It should be understood that a clip according to an embodiment of the invention is intended to function in a similar manner irrespective of the exact configuration of the impact protection device or the cross-sectional wall profile of the post.

FIG. 2 illustrates an impact protection device clip 10 according to an embodiment of the invention. The clip 10 includes a body 12, first and second attachment devices 14, 16, and first and second contacts 18, 20. The first and second contacts 18, 20 are located on an inner end of the body. As depicted in FIG. 4, in use the body 12 of the clip 10 extends through the opening O of the cross-sectional wall profile of the post 200 with the inner end and first and second contacts 18, 20 located within the chamber C of the post 200. The first and second contacts 18, 20 are shown spaced from the inner face 200A of the cross-sectional wall profile of the post 200. However, this may not always be the case. For example, one or both contacts 18, 20 may contact or press against the inner face 200A of the cross-sectional wall profile of the post 200.

The first and second attachment devices 14, 16 of the clip 10 are shown in FIG. 4 secured by inter-engagement to respective curled ends 102, 104 of the impact protection device 100. To this end, each attachment device 14, 16 has a C-shaped curled cross-sectional configuration arranged to engage with a correspondingly shaped end 102, 104 of the impact protection device 100. However, it should be understood that the attachment devices of a clip according to an embodiment of the invention may adopt other forms.

The first and second contacts 18, 20 of the clip 10 are arranged so that if the protection device 100 is moved in a first direction, as indicated by the arrow A, causing a part of the protection device 100 to be pulled generally away from the post 200 in the direction A, the contacts 18, 20 will be caused to engage against the inner face 200A of the cross-sectional wall profile of the post 200. This engagement between the first and second contacts 18, 20 of the clip 10 and the post 200 resists further movement of the protection device 100 in the first direction A, and thereby resists the protection device 100 from being inadvertently removed from its position about the post 200. Unintentional movement of the impact protection device 100 may occur for different reasons. For example, movement may be the result of an impact by a forklift or pallet when product is being loading onto the pallet racking or, for example, may be the result of the impact protection device 100 being caught on a pallet or the like causing the impact protection device 100 to be moved or “dragged” off the post.

It should be understood that although the Figures all illustrate the clip 10 having first and second contacts 18, 20 it is envisaged that a clip including one or more contacts is within the scope of the present invention. For example, a clip according to an embodiment of the invention may include a single contact extending from the body. Indeed, the single contact may be a part of the inner end of the body 12. Such a single contact would operate in a manner similar to either of the first and second contacts 18, 20 as described above. The single contact may include one or more contact points, or a zone of contact.

As shown in FIG. 3, the body 12 of the clip 10 includes a pair of arms each including a first portion 12A and a second portion 12B. The first attachment device 14 is located on a distal end part of the second portion 12B of the first arm and the second attachment device 16 is located on a distal end part of the second portion 12B of the second arm. A spacing is located between the first portions 12A of the arms. The width of the spacing may vary if sideways pressure or a loading is applied to any of the first or second portions 12A, 12B during use of the clip 10.

As shown in FIG. 3, clip 10 has a maximum contact width dimension MW as measured between the outer sides of the contacts 18, 20. Preferably, the maximum contact width dimension MW of the clip 10 is arranged to be greater than the opening dimension OW of the chamber C of a post 200 but, less than or substantially equal to the maximum width dimension of the chamber CW of the post 200. However, it should be understood that due to the resiliently flexible nature of the clip 10, if the clip 10 in use is subject to a loading that forces the contacts 18, 20 towards one another, the maximum contact width dimension MW of the clip 10 may be reduced as compared to the maximum contact width dimension MW when the clip 10 is not subject to any such loading.

FIGS. 5A to 5D illustrate the protection device 100 attached to a post 200. As shown in these Figures, two clips 10 are used to secure the protection device 100 to the post 200. One clip 10 is located at an upper end of the impact protection device 100 and another clip 10 is located at the lower end of the impact protection device 100.

FIG. 6 illustrates an impact protection device 100 connected to a post 300. The cross-section configuration of the post 300 is different to that shown in FIGS. 4 to 5D. However, the clip 10 is still attached to the impact protection device 100 in a similar manner.

FIGS. 7A to 7D illustrate a clip 10 secured to a lower end of the protection device 100 which is located on the post 300. These Figures also illustrate the steps in attaching a clip 10 to an upper end of the impact protection device 100. It should be appreciated that the steps involved in attaching a clip 10 to the impact protection device 100 are similar irrespective of whether the clip 10 is being secured to an upper or lower end of the impact protection device 100. It should also be appreciated that the impact protection device 100 may be modified to allow attachment of the clip 10 to other positions along its length.

The steps in attaching a clip 10 to the impact protection device 100 shown in FIGS. 7A to 7D are as followings:
Insert the clip 10 through the opening O in the post 300 with the clip 10 orientated so that the maximum contact width dimension MW extends substantially vertically (i.e. in the longitudinal direction of the post 300).
When the contacts 18, 20 are located within the chamber C of the post 300 rotate the clip 10 by about 90° and so that the clip 10 is positioned as shown in FIG. 7C.
Pull the clip 10 downwardly so that the attachment devices 14, 16 engage about the curled ends 102, 104 of the protection device 100, thereby attaching the clip 10 to the protection device 100.

It will be noted that when a clip according to an embodiment of the invention is used to secure an impact protection device about a post, the clip is not secured to the post itself. The clip and impact protection device are attached to one another but there is no actual attachment of the clip to the post. Further, the impact protection device need not necessarily be attached to the post. As the impact protection device is arranged to be attached to the clip rather than to the post, the impact protection device and clip can be located about a varying range of post profiles. The resiliently flexible nature of both the impact protection device and the clip further increases their ability to be attached to each other and about a range of differing post profiles.

It will also be noted that the body of the clip extends into the chamber of the post via the opening. The impact protection device extends about the post generally around the “front” and “side” parts of the post. The “rear” part of the post includes the opening which is typically not protected by any part of the impact protection device. A clip according to an embodiment of the invention is attached to the impact protection device from the “rear” of the post and thus does not interfere with the protection of the post normally afforded by a conventional impact protection device.

The embodiments have been described by way of example only and modifications within the spirit and scope of the invention are envisaged.

1. An impact protection device clip configured to locate an impact protection device about a post of a racking system, said post including a cross-sectional wall profile defining a chamber with an opening, said clip including a body arranged in use to extend through said opening, said body further including first and second attachment devices for enabling attachment of the clip to said impact protection device, and said body including at least one contact, and wherein the at least one contact is configured so that if the protection device is moved in a first direction causing a part of the protection device to be pulled generally away from the post, the contact engages against an inner face of the cross-sectional wall profile of the post so that the engagement between the contact of the clip and the post resists further movement of the protection device in the first direction.

2. A clip according to claim 1 wherein the clip is arranged for use with a post having a chamber with a width dimension greater than a width dimension of the opening and the clip includes first and second contacts that have a maximum contact width dimension greater than the width dimension of the opening of the chamber.

3. A clip according to claim 2 wherein the maximum contact width dimension is less than or substantially equal to the width dimension of the chamber.

4. A clip according to claim 2 wherein the at least one contact is located on an inner end of the body which is arranged in use of the clip to located within the chamber of the post.

5. A clip according to claim 2 wherein the first and second contacts are located on respective first and second fingers of the clip.

6. A clip according to claim 5 wherein the width dimension of the first and second contacts is measured from an outer most edge of the first finger to an outer most edge of the second finger.

7. A clip according to claim 6 wherein the first and second fingers extend outwardly from a first end of the body and at an angle to one another.

8. A clip according to claim 1 wherein the body is elongated so that in use of the clip, the first and second attachment devices are located outside of the chamber.

9. A clip according to claim 8 wherein the body has a body width dimension less than the width dimension of the opening of the chamber so that the body may extend through said opening during use of the clip.

10. A clip according to claim 1 wherein the body includes a pair of arms that each includes a first portion that extends in use of the clip generally perpendicular to the width dimension of the chamber.

11. A clip according to claim 10 wherein each arm includes a second portion that extends generally parallel to the width dimension of the chamber.

12. A clip according to claim 11 wherein the first attachment device is located on a distal end part of the second portion of the first arm and the second attachment device is located on a distal end part of the second portion of the second arm.

13. A clip according to claim 1 wherein the clip is resiliently flexible.

14. A kit including an impact protection device for a pallet racking post and a clip according to claim 1.

15. A method of preventing inadvertent removal of a clip from an impact protection device located about a pallet racking post, said post including a cross-sectional wall profile defining a chamber with an opening, said clip including a body with at least one contact, said method including the steps of:
positioning the at least one contact of the clip so that the contact is received in the chamber of the post and the body extends through the opening of the post; and
attaching the clip to the impact protection device so that the impact protection device is located about the post
whereby when the impact protection device is subject to an impact or other contact that causes a part of the impact protection device to move generally away from the post, the clip is arranged to resist further movement of the impact protection device away from the post by establishing an engagement between the at least one contact of the clip and an inner face of the cross-sectional wall profile of the post.

16. A method according to claim 15 wherein the clip includes two contacts and wherein the contacts limit or prevent twisting of the clip by each engaging against the inner face of the cross-sectional wall profile of the post when the impact or other contact causes a part of the impact protection device to move generally away from the post.

17. A method according to claim 15 wherein the clip is not secured to the post.

18. A method according to claim 15 wherein the impact protection device is not secured using any separate connector to the post.

19. A method according to claim 15 wherein the clip and/or impact protection device are subject to flexure when attaching them together about the post.
